(19) United States
(12) Patent Application Publication
(10) Pub. No.: US 2015/0359377 A1
(43) Pub. Date: Dec. 17, 2015

(54) Single Cup Beverage Maker and Method of Using Same

(71) Applicant: Robert William Graham, Dayton, OH (US)

(72) Inventor: Robert William Graham, Dayton, OH (US)

(21) Appl. No.: 14/306,211

(22) Filed: Jun. 16, 2014

(51) Int. Cl. A47J 31/40; A47J 31/56; A47J 31/46

(52) U.S. Cl. CPC A47J 31/407; A47J 31/46; A47J 31/56

(57) ABSTRACT

A single cup brewer for use with a single cup brewer filter basket includes a base and a housing connected to and extending upward from the base and has a single cup filter basket zone and includes an actuator for securing the filter basket in the zone.

### BACKGROUND OF THE INVENTION

1. Field of Invention

This invention relates to beverage makers, particularly coffee makers adapted for using single cup basket filters with a high pressure and heat and to a method for using the same.

2. Prior Art

Drip-type electric brewing machines have been used as an efficient means for making coffee and other beverages such as tea. The brewing machine typically has a cold water reservoir, an electric resistance heating element for heating the water, and a reusable plastic brew basket for holding ground ingredients in a paper filter. To make coffee, cold water is poured into the water reservoir and ground coffee is placed in a coffee filter, which is in turn placed in the brew basket. The cold water is heated by the electric heating element, and the heated water then saturates the ground coffee. The brewed coffee then drips out into a pot below the brew basket. The paper filter and used coffee grounds are taken out of the plastic brew basket and discarded. Then, the brew basket and coffee pot are cleaned for re-use.

Recently, there has been a trend to provide a single use disposable brew pod for a single cup electric coffee brewing machine that is designed for brewing a single cup of coffee directly into a coffee cup. This was designed with the thought of providing a quick and convenient cup of coffee on demand.

A trendy brand of pod has been introduced by Keurig, Inc. in which a single use coffee pod works within its beverage pod receiver. This is seen in U.S. Pat. No. 7,513,192. Other such coffee makers of using single cup pods include Cuisinart, Tassimo and Mr. Coffee types typically which also employ filter cups which are part of a sealed pod which include ground coffee or other ingredients therein. The pods typically have a polymer filter which is adhered to the wall of the plastic pod. The filter in such pods is plastic to withstand the high pressure and heat which is posed by a single stream of intense water pressure, as opposed to conventional drip coffee makers. These pods pose a significant environmental issue and are very costly and a health concern.

In addition to these pods, other solutions have been tried. For example, one solution uses a technique of providing a metal foil or plastic web filter basket which is removably enclosed in a pod having an opening on a top and bottom. This device must be washed out which is difficult to do as the area within such pod is less than a couple of inches and it is difficult to access for purposes of cleaning. Moreover, this takes away from the convenience of single cup brewing. After a while these baskets get stained or clogged and are less desirable.

Another device attempted to use a non metal disposable filter which has a bottom cup and an upper lid and hingedly adhered at an edge to the cup and which can be filled with ground coffee and then enclosed in a snap fit manner within a second plastic cup having a small opening therein and a lid connected to the second cup, the lid having a hole therein to receive the conduit of the coffee maker. This too has flaws. The filter is expensive to make and is awkward to maintain open for filling the bottom cup with coffee.

Prior alternatives result in an inferior brew. This is due to the fact that the stream of high pressure causes a channel to be formed centrally through the pod and grounds as this is the path of least resistance. Accordingly, a weak cup of coffee is provided.

Applicant invented in co-pending application a re-usuable single cup filter basket which uses paper filters to provide an excellent cup of coffee. In so doing, current applicant developed an improved single cup brewer for use with the improved filter basket.

There is a need for a more desirable high pressure single cup brewer which overcomes the deficiencies in the art, namely, ease of use, reliability and cost. The instant invention provides a solution which overcomes these prior deficiencies.

### SUMMARY OF THE INVENTION

It is an object of the invention to provide new and improved pressurized single cup type brewer.

It is another object to provide a method of using the same for brewing beverages.

It is a further object to minimize waste in brewing single cup beverage.

It is another object to improve the efficiency and cost of a single use brewing machine.

A single cup brewer for use with a single cup brewer filter basket having a top of a first diameter with an opening and a bottom with an opening through which fluid flows, wherein the single cup brewer comprises a base, a housing connected to and extending upward from the base and having a single cup filter basket receiving zone. The single cup filter basket receiving zone includes a single cup filter basket receiving support surface for receiving and supporting the filter basket. The filter basket receiving zone permits insertion and removal of the filter basket on the single cup filter basket receiving support surface and the single cup filter basket receiving support surface includes an open surface of smaller diameter than a diameter of the opening in the bottom of the filter basket. A cup receiving zone is disposed beneath the single cup filter basket receiving zone for receiving fluid through the open surface of the support surface.

A top on the housing has a water receiving inlet through which fluid can be poured. A water vessel is connected to the housing to receive water therein via the water receiving inlet. A heating element operably connects to the water vessel.

A water delivery conduit operably connects to an outlet of the water vessel and has a terminal end disposed above the filter basket receiving zone such that when the filter basket is disposed on the filter basket receiving support surface, the terminal end of the conduit is disposed over the filter basket top opening and generally relative co-axial movement between the terminal end and the filter basket is provided to provide a sealed connection in a manner to enable water to enter and pass through the filter basket.

A pump is operably connected to the water vessel to enable water to be purged from the water vessel. A powered controller operably connects to the housing for controlling operation of the heating element and the pump. A switch is provided for activating the controller to cause heating element to heat the water vessel and subsequently initiate the pump to pump water from the water vessel through and out the water delivery conduit. A concave holding surface in the top is defined for receiving water about the water inlet and through it passes. A valve mechanism, such as a solenoid, is connected to the water vessel for aiding water entry into the water vessel.

Further objects of the invention are to avoid the disadvantages of the prior art and to obtain such other advantages as will appear as the description proceeds.

### BRIEF DESCRIPTION OF THE DRAWINGS

FIG. 1 shows a perspective exploded view of an aspect of the invention.

FIG. 2 shows a top view of the invention with hidden lines in FIG. 1.

FIG. 3 shows a side sectional view through a top of the invention in FIG. 1.

FIG. 4 shows a side sectional view through an insert of the invention in FIG. 1.

FIG. 5 shows a side sectional view through a basket retainer of the invention in FIG. 1.

FIG. 6 shows a top perspective view of the invention in FIG. 1.

FIG. 7 shows a bottom perspective view of the invention in FIG. 1.

FIG. 8 shows a side view of the invention in FIG. 1.

FIG. 9 shows another bottom perspective view of the invention.

FIG. 10 shows a cross section of part of the filter of the invention as disposed in press-fit relation within the insert and retainer of the invention.

FIG. 11 shows a cross section through line A-A of FIG. 10.

FIG. 12 shows a cross section through line B-B of FIG. 10.

FIG. 13A shows a perspective view of an embodiment of the maker of the invention with an open front for receiving a filter basket of the invention.

FIG. 13B shows a perspective view of another embodiment of the maker of the invention with a swing door for receiving a filter basket of the invention.

FIG. 13C shows a perspective view of still another embodiment of the maker of the invention with a slide door for receiving a filter basket of the invention.

FIG. 14 shows a cutaway sectional view of the invention revealing components of the invention.

FIG. 15 shows a perspective of a part of the invention.

FIG. 16 shows a perspective of another part of the invention.

FIG. 17 shows a schematic layout of operational components of the invention.

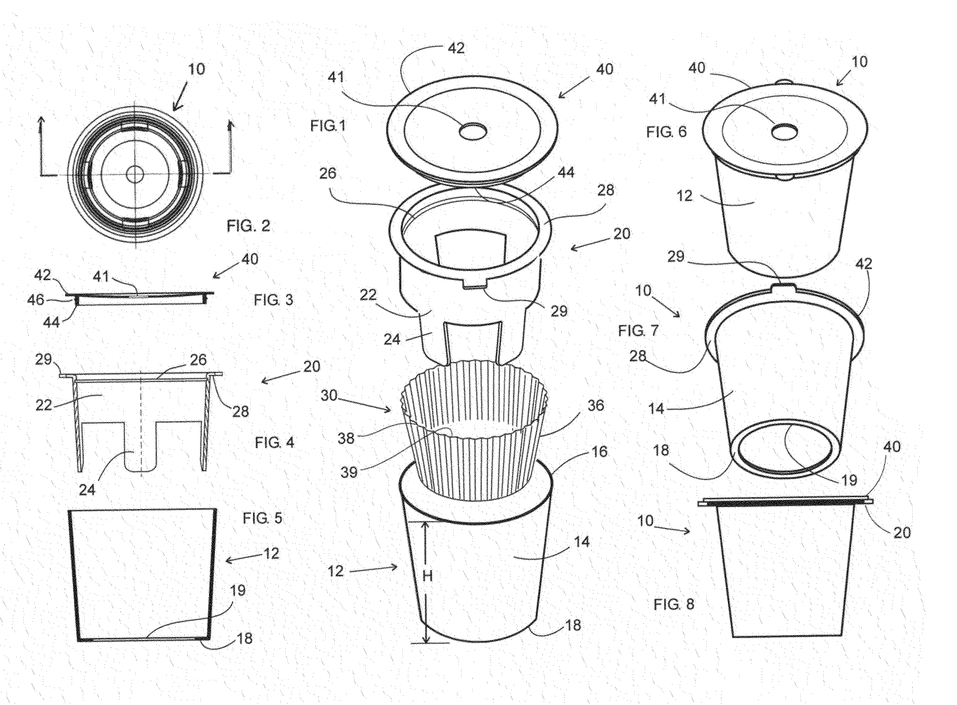

### DETAILED DESCRIPTION OF PREFERRED EMBODIMENTS

Referring now to the drawings, like numerals refer to like parts. A single cup brewer 1000 for use with a single cup brewer filter basket is generally referred to by the numeral 10. The single cup brewer filter basket 10 has a top 16 of a first diameter with an opening and a bottom 18 with an opening through which fluid flows. The single cup brewer 1000 which comprises a base 1002 which is shown here as tapered, but other configurations are envisioned.

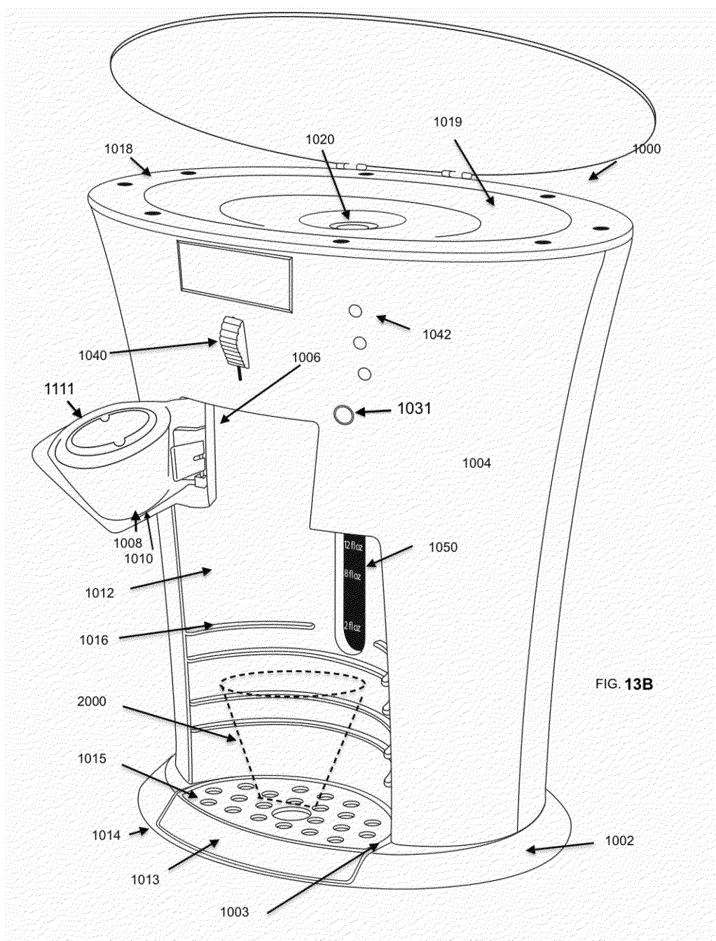

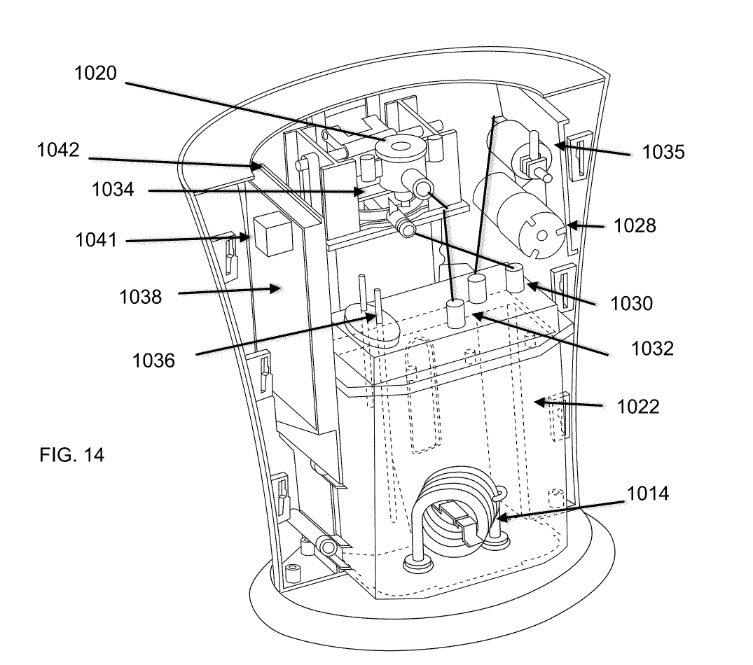

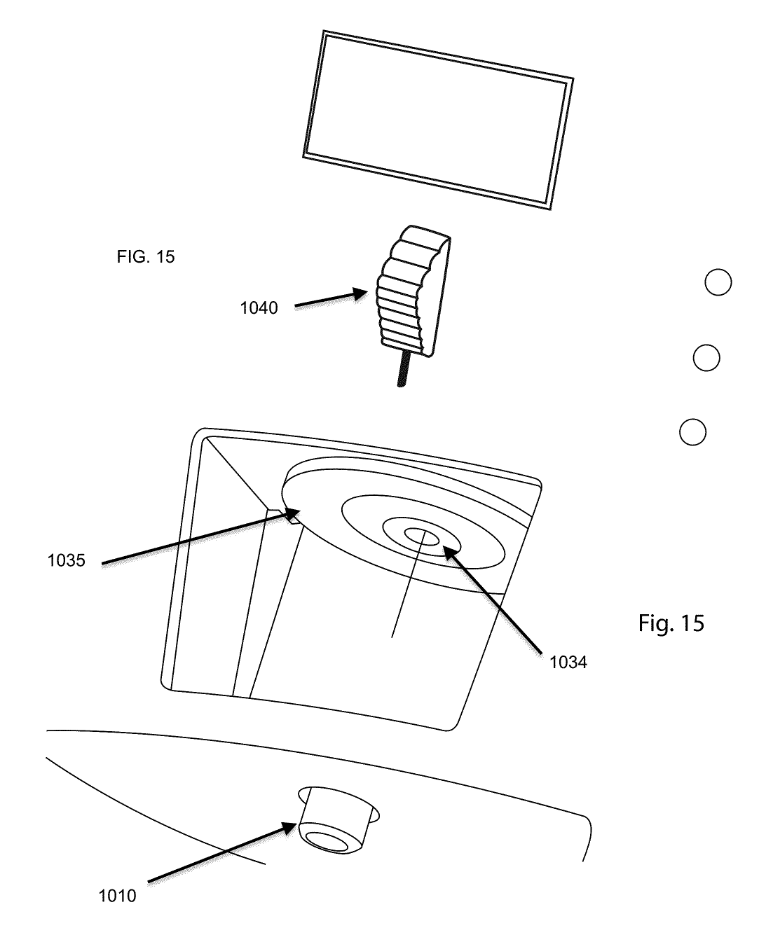

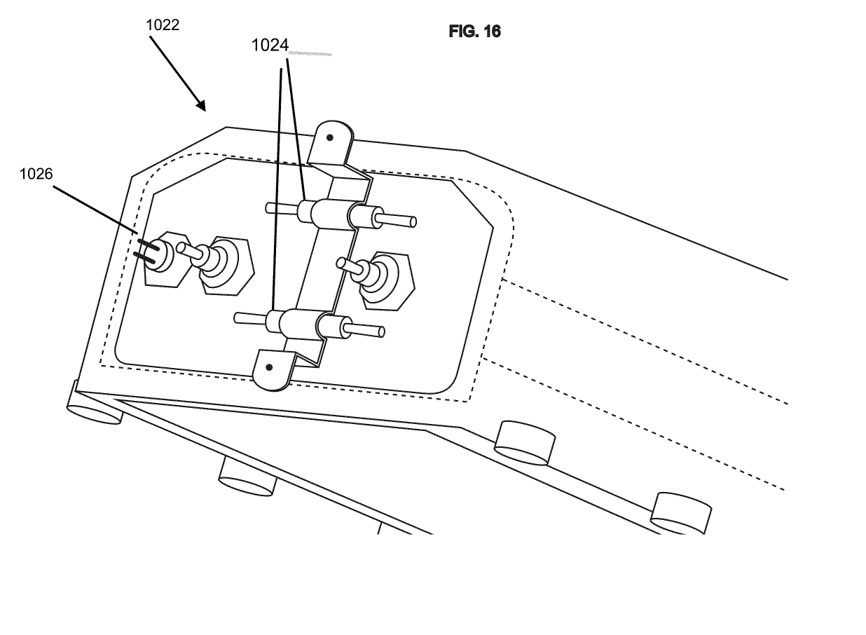

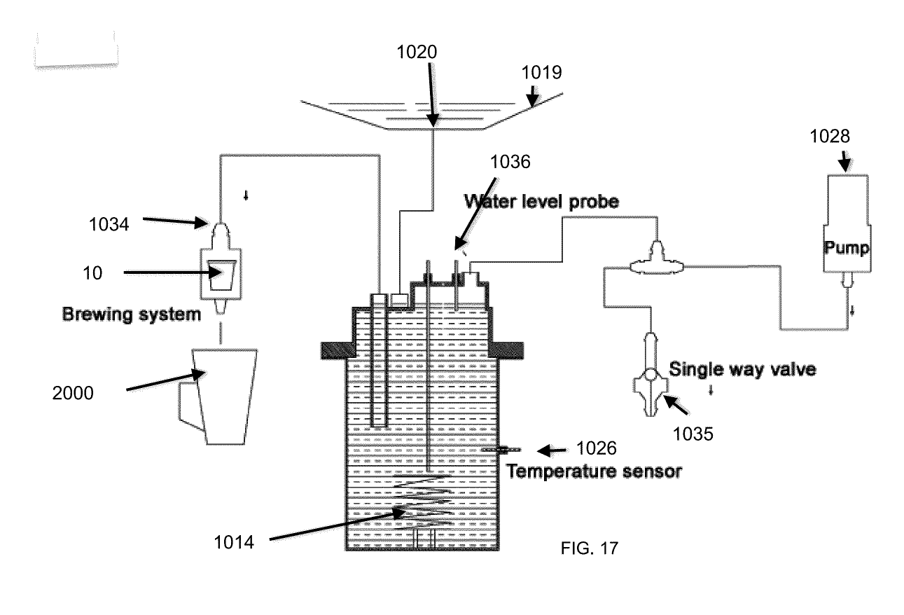

A housing 1004 is connected to and extends upward from the base 1002 and has a single cup filter basket receiving zone 1006 which includes a single cup filter basket receiving support surface 1008 for receiving and supporting the filter basket 10. Several embodiments are contemplated. In FIG. 13A, the single cup filter basket receiving support surface 1008 can include a sliding door 1109 which includes a bucket 1111 (which can be removably connected to the sliding door 1109); in FIG. 13B the single cup filter basket receiving support surface 1008 can be part of a swinging door or FIG. 13B which can be held in place via a spring locking mechanism or detent mechanism; or be stationary as seen in FIG. 13C. It is contemplated, there can be a push release button 1031 which actuates to release the spring locking mechanism forcing the door outward to enable insertion of the filter basket 10.

The filter basket receiving zone 1006 preferably permits insertion and removal of the filter basket 10. As illustrated in FIG. 13C, single cup filter basket receiving support surface 1008 includes a bottom open surface 1010 therethrough of smaller diameter than a diameter of the filter basket 10 and under which a cup 2000 can be disposed for receiving fluid through the bottom open surface 1010. Note, it to be understood that in the surface 1008 is formed in bucket 1111 of FIG. 13A and FIG. 13B.

The housing 1004 also preferably includes a recessed surface 1012 and height adjustable cup surface 1014 movably disposed therein for receiving cup 2000 thereon. The height adjustable cup surface 1014 includes at least one retaining surface 1016 for retaining the height adjustable cup surface 1014. The height adjustable cup surface 1014 can preferably be configured to fit within a receiving surface 1003 of base 1002 and can be configured to include a lower tray 1013 and removable upper surface 1015 having apertures to let overflow fluid be captured within the tray 1013.

A top 1018 on the housing 1004 has a water receiving inlet 1020 defined in a recessed area 1019 through which fluid can be poured. As seen in FIG. 13 A, a reclosable lid 1113 can be hingedly connected to top 1018 to close about the area 1019 and includes a seal 1116 to seal about the inlet 1020. A protruding lip 1114 extends from the lid 1113 to secure the lid too the top 1018 by way of a movable latch 1115 which is operably connected to the top 1018.

A water vessel 1022 is connected to the housing 1004 to receive water therein via the water receiving inlet 1020. A heating element 1024 which can include one or more thermal fuse(s) coupled to a conductive coil is operably connected to the water vessel 1022. NTC thermistor 1026 can be operably connected to the housing 1004 for temperature control. A pump 1028 is operably connected to the water vessel 1022 to enable water to be purged therefrom. A water delivery conduit 1030 operably connects to an outlet 1032 of the water vessel 1022 and has a terminal end 1034 disposed above recessed surface portion 1009 (which also includes drain grooves 1011) of the filter basket receiving support surface 1008 such that when the filter basket 10 is disposed in the filter basket receiving support surface 1008, the terminal end 1034 of the conduit is disposed over the filter basket top opening 41.

Generally relative co-axial movement between the terminal end 1034 and the filter basket 10 is provided in a manner to cause engagement thereof in a manner to enable water to enter and pass through the filter basket 10. One or more water level sensor probes 1036 (situated at different water level heights to sense water levels) are operably connected within the housing 1004. Also, an exhaust valve 1035, such as a solenoid valve, is operably connected to the conduit 1030.

The maker 1000 can one or more controllers circuit boards 1038 which operably connects to and controls heating of water vessel 1022 (boiler)(2000W), the NTC thermistor 1026 (water temperature control 87-89°), sensor probes 1036, control air pump 1028 (12V) and exhaust valve 1035 (12V), water level sensor probe 1036, a 12V micro switch 1041; a lamp board 1042 having operably connected red, blue, green LED lights (which colors are by example). A plug (not shown) is operably connected to the coffee maker 1000 and switch 1040.

When the maker 1000 is powered on, the red LED lights to indicate to add water to the boiler 1022. When one the probes 1036 becomes sensitive to water level, then water is sufficient to the minimum water level. The controller 1038 activates heating element 1024 and coil 1014 and using the NTC thermistor 1026, the water is heated to 87-89° C. and then heating is stopped and a blue LED lights during heating. A green LED lights after completion of the heating and commences the purging of the water from the boiler 1022 via activating pump 1028.

One exemplary LED pattern can be as follows:

| Function | LED State | Figure(s) |
|---|---|---|
| Power ON - Ready | Red LED - Solid. | [symbol] |
| | Top LED - Solid Red. | |
| | Middle LED - OFF | |
| | Bottom LED - OFF | |
| Power ON - Boiler Full | Middle LED - Flashing | [symbol] |
| | Blue when water level | |
| | enough turn to solid. | |
| Brew Cycle Started - Water | Bottom LED - Flashing | [symbol] |
| Heating. | Green and turn solid when | |
| | done. | |

Another example lighting can be:

| Function | LED State | Figure(s) |
|---|---|---|
| Power ON - Ready | Blue LED - Solid. Top LED - Solid Blue. Middle LED - OFF Bottom LED - OFF | 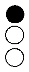 |
| Power ON - Boiler Full | Top LED - Flashing Blue. Middle LED - OFF Bottom LED - OFF (Note: If the boiler has insufficient water, top LED remains solid and Alarm LED lights if brew cycle is triggered indicating low water). | 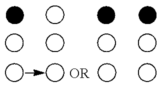 |
| Brew Cycle Started - Water Heating. | Top LED - OFF Middle LED - Flashing Green. | 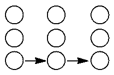 |
| Brew Cycle Started - Water Dispensing. | Top LED - OFF Middle LED - Solid Green Bottom LED - OFF (unless alarm condition exists) | 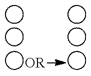 |
| Alarm Condition - Insufficient Water. | Top LED - Solid Blue Middle LED - OFF Bottom LED - Flashing RED | 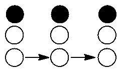 |
| Alarm Condition - Other | Top LED - OFF Middle LED - OFF Bottom LED - Solid RED. | 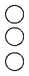 |

A second water level sensor probe 1036 is disposed such that when the water level reaches the highest water level, an alarm can preferably be sounded by a sound chip on the controller 1038. While the exhaust valve 1035 is powered off, and the other cycles have been completed the heating stops lights emit as indicated, (the exhaust valve opens, the heating tube heating is continued, heating stops when the NTC thermistor 1026 induction to water heated to 87-89°.

A micro switch 1041 is closed after the pump 1028 to begin to work, if the water temperature is less than predetermined temperature level of 87-89° C., air pump 1028 does not work. If the temperature is below 87° C. degrees in the working process of the maker 1000 does not operate (i.e., the air pump 1028 of the maker 1000 will not start because temperature drop). The micro switch 1041 can preferably only start the pump 1028 going.

A concave water catch surface 1019 in the top 1018 defines a volume sufficient to hold a some overflow of water as it is poured (less than 12 oz, for example) which is to pass through the water inlet 1020. A line of sight water level 1050 can be provided in the recessed surface 1012 which is operably connected to the water vessel 1022 in a manner to reveal the amount of water therein.

The switch 1040 actuates the outlet 1034 into and out of engagement with the top 40 of the filter basket 10 when disposed in the recessed surface 1009. In this regard, the terminal end 1034 includes a top engaging portion 1035.

Removable top 40 is provided which has outer perimeter lip portion 42 with a diameter of at least that of the diameter of the upper end 16 of the retainer 12 and has a lower collar portion 44 of a diameter less than the diameter of the upper collar 16 and configured to press-fit therein to secure the insert 20 within the retainer 12. The removable top 40 has an opening therethrough which can preferably be centrally located and which is of a size to receive a water delivery conduit 100 therethrough in a substantially seal tight manner to prevent water backing out the opening in top 40. In this regard a seal (not shown) may be provided about the conduit to abut about the opening and conduit to prevent back flow.

The basket 10 includes a filter retainer 12 having an outer shell 14 with an upper end 16 having open top and a bottom 18 including a generally centrally located opening 19 therein. The shell 14 has a predetermined height H, which can be a length of about 1.5 inches. The bottom 18, the bottom 18 which is the form of an annular ring of a radial length X. The opening 19 is preferably large enough to permit insertion of one's finger therethrough. The diameter of the bottom 18 is a predetermined diameter Y which can preferably be about less than about 1.5 inch for the case of a K-cup alternative. The upper end 16 is predetermined diameter Y+Δ which is greater than Y. In this way, the outer shell is tapered.

An insert 20 is provided having an upper collar 22 of a less than the diameter of the upper end 16 of the retainer 12 to fit therein and has a lower extension 24 (which can include a plurality of fingers). The collar 22 and extension 24 are integral and form a taper in spaced relation to the shell 14. In the shown embodiment, the extension 24 form legs which leave gaps therebetween to enhance fluid flow therethrough. With the maker 1000 of the instant invention, the collar 2 length can be extended so that the legs 24 extend closer to the bottom 18 of the retainer 12. In this way, filter 30 can be disposed to rest adjacent the support surface 1008.

Filter 30 can be generally cup shaped and disposed between the retainer 12 and the insert 20 such that the insert 20 press-fits the filter 30 within the retainer 12 to retain the filter 30 adjacent the retainer shell 14 as described herein. The filter 30 can preferably be at least about 30-32 pound basis weight and has a substantially planar base portion 32 having a generally rounded periphery. The base portion 32 has an inside surface 33 for receipt of beverage forming ingredient and an outside surface 34. The filter 30 has a substantially annular sidewall portion 36 which extends upwardly and radially outwardly from the rounded periphery of the planar base portion 32, the annular sidewall portion 36 having an inner surface 37 for receipt of beverage forming ingredient and an outer surface 31 for disposal against the shell 14. The base portion 32 can be less than the diameter of the Y diameter of the outer shell 14, for example, less than 1.5″ for example for K-cup alternative. The length of the sidewall 36 should be less than the height H of the outer shell 14, less than 1.5″ for example for K-cup alternative.

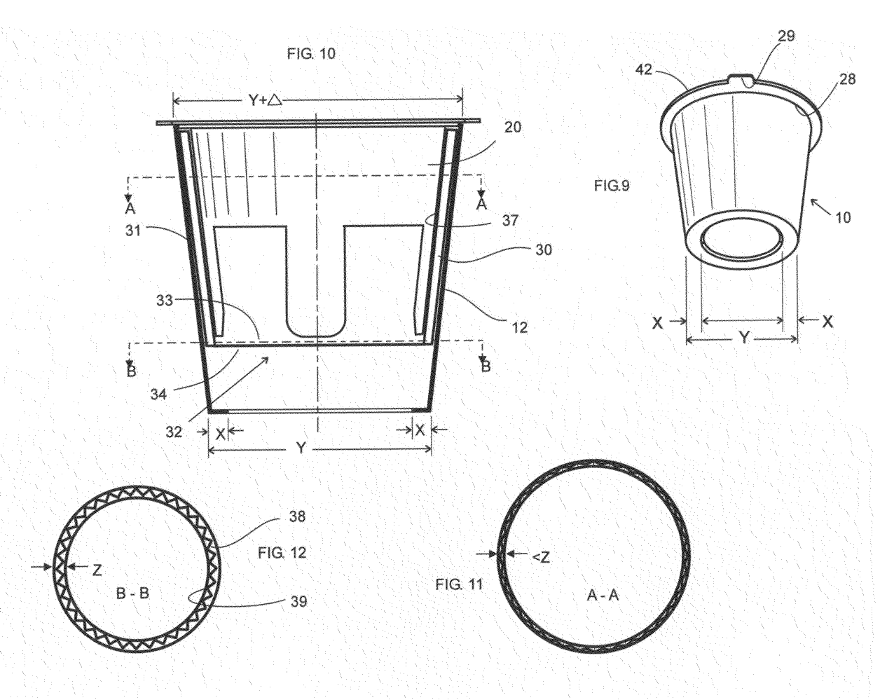

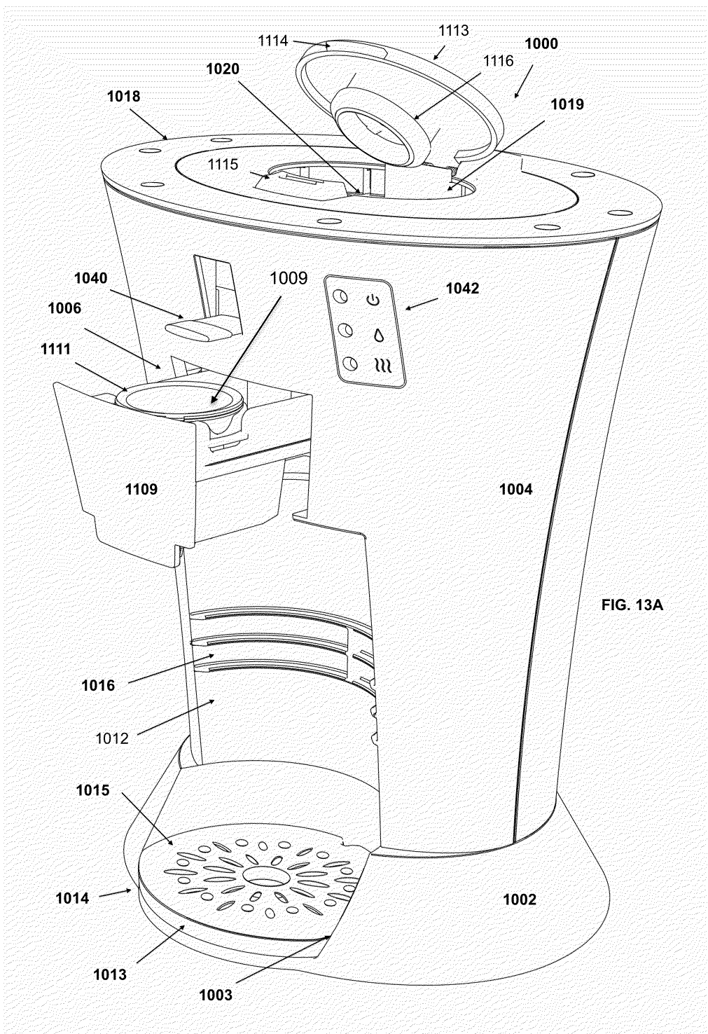

The annular sidewall 36 includes a plurality of ridges 38 extending radially outwardly and valleys 39 extending radially inwardly. The ridges 38 and valleys 39 are separated by a distance Z, for example less than about 2-3 mm for example when formed. The plurality of ridges 38 and valleys 39 cooperate when press-fit between the insert 20 and retainer 12 to enhance the flowability of liquid through the filter 30. As illustrated in FIGS. 10 and 11, the filter 30 when inserted between the insert 20 and retainer 12, is sufficiently compressed to enable self retention, but not so much as to inhibit fluid flow. The ridges 38 and valleys 39 are separated by a predetermined distance Z which is greater than zero and less than 0.5 cm and the insert 20 has an external diameter less than an internal diameter of the retainer 12 and wherein when the insert 12 is within the retainer 20, the insert 12 is diametrically separated from retainer 20 less than distance Z and greater than zero. The FIG. 12 illustrates the filter 30 in uncompressed area.

The filter 30 can preferably be made of cellulose fiber from chemically prepared wood from a wet crepe filter paper machine strength and flow rate. The filter 30 should be of a strength to withstand high pressure and heat from water injection from single cup coffee makers.

Further, the upper collar 22 can preferably include a peripheral lip 28 of a diameter at least that of the upper end 16 of the retainer 12 and preferably larger, to aid in removal of the insert 20. The peripheral lip 28 can include a tab 29 (or optionally a cut-off edge) to aid in separation from lip portion 42 of removable top 40. In this regard, the lip 28 can be slight smaller than the diameter of lip portion 42 while the tabs 29 extend laterally outward greater diametrically than the diameter of the lip portion 42. The lip 28 has a diameter of at least that of (and preferably greater than) the diameter of the upper end 16 of the retainer 12

Removable top 40 is provided has outer perimeter lip portion 42 with a diameter of at least that of (and preferably greater than) the diameter of the upper end 16 of the retainer 12 and has a lower collar portion 44 of a diameter less than the diameter of the upper collar 16 and configured to press-fit therein to secure it to the insert 20. The removable top 40 has an opening 41 therethrough which can preferably be centrally located and which is of a size to receive a water delivery conduit 1034 in a substantially seal tight manner to prevent water backing out the opening in top 40. In this regard a seal (not shown) may be provided about the conduit to abut about the opening 41 and conduit to prevent back flow.

Further, the lower collar portion 44 of the top 40 and the collar 22 of the insert 20 can be formed with a complementary detent mechanism to snap fit together and secure the two together for use and removal. By way of example, the collar portion 44 can include a radial protrusion 46 and the collar 22 can include an inner radial recess surface 26 to form the snap-fit relation. While tab 29 is shown, it is contemplated that an edge of either of the peripheral lip 28 of the insert 20 or the lip portion 42 of the top 40 can be recessed or extended to aid in separation of the two once connected.

The filter 30 can be formed by die stretching in a manner to set the filters in the desired shape. A mold can include a body having a planar base portion having a rounded periphery, the base portion having an inside surface for receipt of the disc, an annular sidewall portion which extends upwardly and radially outwardly from the rounded periphery of the planar base portion and includes a plurality of radially outwardly extending ridges and radially inwardly extending valleys, where it is understood there are complementary male and female components.

The preferred embodiments are intended for illustrating only and are not intended for limiting the claims. As such, modifications, derivations and improvements are to be covered by the appended claims hereto. It is to be understood that the invention is not to be limited to the exact details of operation or structure shown and described, as obvious modifications and equivalents will be apparent to one skilled in the art.

What is claimed is:

1. A single cup brewer for use with a single cup brewer filter basket which has a top of a first diameter with an opening and a bottom with an opening through which fluid flows, which comprises:
a base;
a housing connected to and extending upward from said base and having a single cup filter basket receiving zone which includes a single cup filter basket receiving support surface for receiving and supporting the filter basket, wherein said filter basket receiving zone permits insertion and removal of the filter basket and wherein said single cup filter basket receiving support surface includes a bottom open surface of smaller diameter than a diameter of the filter basket, and wherein a cup can be disposed underneath said single cup filter basket receiving support surface for receiving fluid through said bottom open surface;
a top on said housing having a water receiving inlet through which fluid can be poured;
a water vessel connected to said housing for receiving water therein via said water receiving inlet and having a heating element operably connected to said water vessel;
a pump operably connected to said water vessel to enable water to be pumped therefrom;
a water delivery conduit operably connecting to an outlet of said water vessel and having a terminal end disposed above said filter basket receiving support surface such that when the filter basket is disposed on said filter basket receiving support surface, said terminal end of said conduit is disposed over the filter basket top opening and provides for generally relative co-axial movement between said terminal end and said filter basket in a manner to cause engagement there between and enable water to enter and pass through the filter basket;
a powered controller operably connected to said housing for controlling operation of said heating element and said pump; and
a switch for activating said controller to cause heating element to heat said water vessel and subsequently initiate said pump to pump water from said water vessel through and out said conduit.

2. The single cup brewer of claim 1, which further includes an actuator connected to said terminal end of said conduit for actuating said terminal end into and out of an engaging position with the filter basket when operably disposed on said filter basket receiving support surface.

3. The single cup brewer of claim 1, which further includes a valve communicably connected to said water receiving inlet.

4. The single cup brewer of claim 1, which further includes a height adjustable cup receiving support surface operably connected to said housing below said single cup filter basket receiving zone.

5. The single cup brewer of claim 1, which includes a water level sensor operably connected to said controller and said water vessel.

6. The single cup brewer of claim 1, which includes a temperature sensor operably connected to said controller and said water vessel.

7. The single cup brewer of claim 1, wherein said top on said housing is formed with a preliminary holding surface defining a volume sufficient to hold overflow water which is to pass through said water receiving inlet.

8. The single cup brewer of claim 1, wherein filter basket receiving support surface includes a recessed surface larger than a bottom of the filter basket and wherein said recessed surface includes said bottom open surface therethrough.

9. The single cup brewer of claim 1, which includes a line of sight water level gauge.

10. The single cup brewer of claim 1, further comprising;
said filter basket having a filter retainer of a configuration to fit within single cup filter basket receiving zone having an upper end having open top and a bottom including an opening therein and an insert having an upper end of a diameter less than the diameter than said upper end of the filter retainer and having a lower extension which when a filter is disposed within said filter retainer and said insert, said lower extension of said insert fits within a continuous upper extending wall portion of the filter within said filter retainer to retain the filter adjacent said filter retainer.

11. The brewer of claim 10, wherein said filter basket further includes a removable top having an outer perimeter lip portion with a diameter approximate that of a diameter of said upper end of said filter retainer and a lower collar portion of a diameter less than the diameter of said upper end of said insert and configured to fit therein and when so fitted secures said insert within the filter and said filter retainer, and wherein said removable top has an opening therethrough of a size and configuration to receive said terminal end of said water delivery conduit in a manner to inhibit leakage therebetween.

12. The brewer of claim 10, which includes a filter having a bottom portion and a continuous upper extending wall portion for use in said filter basket.

13. The brewer of claim 10, wherein said upper end of said insert includes a peripheral lip of a diameter at least that of said upper end of said retainer to aid in removal of said insert.

14. The brewer of claim 10, wherein said lower extension includes a plurality of fingers.

15. The brewer of claim 10, wherein said bottom of said filter retainer includes an annular collar about defining said bottom opening which aids to retain the filter.

16. The brewer of claim 10, wherein said bottom opening of said filter retainer is of a size to permit one's finger to be inserted therethrough.

17. The brewer of claim 10, where said engagement causes a seal between said upper end of said filter retainer and said terminal end of said water delivery conduit.

18. The brewer of claim 10, where said engagement causes a seal between said removable top and said terminal end of said water delivery conduit.
